(19) United States
(12) Patent Application Publication
(10) Pub. No.: US 2022/0351039 A1
(43) Pub. Date: Nov. 3, 2022

(54) FEDERATED LEARNING USING HETEROGENEOUS MODEL TYPES AND ARCHITECTURES

(71) Applicant: Telefonaktiebolaget LM Ericsson (publ), Stockholm (SE)

(72) Inventors: Perepu SATHEESH KUMAR, Chennai (IN); Saravanan M., Chennai (IN); Swarup Kumar MOHALIK, Bangalore (IN); Ankit JAUHARI, Bangalore (IN); Anshu SHUKLA, Bangalore (IN)

(73) Assignee: Telefonaktiebolaget LM Ericsson (publ), Stockholm (SE)

(21) Appl. No.: 17/766,025

(22) PCT Filed: Oct. 4, 2019
(86) PCT No.: PCT/IN2019/050736

§ 371 Date: Apr. 1, 2022

(51) Int. Cl. G06N 3/08

(52) U.S. Cl. CPC G06N 3/08

(57) ABSTRACT

A method on a central node or server is provided. The method includes: receiving a first model from a first user device and a second model from a second user device, wherein the first model is of a neural network model type and has a first set of layers and the second model is of the neural network model type and has a second set of layers different from the first set of layers; for each layer of the first set of layers, selecting a first subset of filters from the layer of the first set of layers, for each layer of the second set of layers, selecting a second subset of filters from the layer of the second set of layers; constructing a global model by forming a global set of layers based on the first set of layers and the second set of layers, such that for each layer in the global set of layers, the layer comprises filters based on the corresponding first subset of filters and/or the corresponding second subset of filters; and forming a fully connected layer for the global model, wherein the fully connected layer is a final layer of the global set of layers.

### TECHNICAL FIELD

Disclosed are embodiments related to federated learning using heterogeneous model types and architectures.

### BACKGROUND

In the past few years, machine learning has led to major breakthroughs in various areas, such as natural language processing, computer vision, speech recognition, Internet of Things (IoT), including areas related to automation and digitalization of tasks. Much of this success has been based on collecting and processing large amounts of data (so-called “Big Data”) in a suitable environment. For some applications of machine learning, this need of collecting data can be incredibly privacy-invasive.

For instance, as examples of such privacy-invasive data collection, consider models for speech recognition and language translation, or for predicting the next word that is likely to be typed on a mobile phone to help people type more quickly. In both cases, it would be beneficial to directly train the models on user data (such as what a specific user is saying or typing), instead of using data from other (non-personalized) sources. Doing so would allow training models on the same data distribution that is also used for making predictions. However, directly collecting such data is problematic for various reasons, and notably because such data may be extremely private. Users do not have interest to send everything they type to a server outside their control. Other examples of data that users may be particularly sensitive about include financial data (e.g. credit card transactions), or business or proprietary data. For instance, telecom operators collect data regarding alarms triggered by nodes operated by the telecom (e.g. for determining false alarms vs. real alarms), but such telecom operators do not typically want to share this data (including customer data) with others.

One recent solution for this is the introduction of federated learning, a new approach to machine learning where the training data does not leave the users' computer at all. Instead of sharing their data, individual users compute weight updates themselves using locally available data. It is a way of training a model without directly inspecting users' data on a centralized server. Federated learning is a collaborative form of machine learning where the training process is distributed among many users. A server has the role of coordinating everything, but most of the work is not performed by a central entity but instead by a federation of users

In federated learning, after the model is initialized, a certain number of users may be randomly selected to improve the model. Each randomly selected user receives the current (or global) model from the server and uses their locally available data to compute a model update. All these updates are sent back to the server where they are averaged, weighted by the number of training examples that the clients used. The server then applies this update to the model, typically by using some form of gradient descent.

Current machine learning approaches require the availability of large datasets. These are usually created by collecting huge amounts of data from users. Federated learning is a more flexible technique that allows training a model without directly seeing the data. Although the learning algorithm is used in a distributed way, federated learning is very different to the way machine learning is used in data centers. Many guarantees about statistical distributions cannot be made and communication with users is often slow and unstable. To be able to perform federated learning efficiently, proper optimization algorithms can be adapted within each user device.

### SUMMARY

Federated learning is based upon building machine learning models based on data sets that are distributed across multiple devices, while preventing data leakage from those multiple devices. In existing federated learning implementations, it is assumed that users try to train or update the same model type and model architecture. That is, for instance, each user is training the same type of Convolutional Neural Network (CNN) model having the same layers and each layer having the same filters. In such existing implementations, users do not have the freedom to choose their own individual architecture and model type. This can also result in problems such as overfitting the local model or under-fitting the local model, and if the model type or architecture is not suitable for some users then it may result in a suboptimal global model. Accordingly, improvements to existing federated learning implementations are required to address these and other problems. Such improvements should allow users to run their own model type and model architecture, while a centralized resource (such as a node or server can be used to handle these different model architectures and model types, e.g. by intelligently combining the respective local models to form a global model.

Embodiments disclosed herein allow for heterogeneous model types and architectures among users of federated learning. For example, users may select different model types and model architectures for their own data and fit that data to those models. The best working filters locally for each user may be used to construct a global model, e.g. by concatenating selected filters corresponding to each layer. The global model may also include a fully connected layer at the output of the layers constructed from local models. This fully connected layer may he sent back to the individual users with the initial layers fixed, where only the fully connected layer is then trained locally for the user. The learned weights for each individual user may then be combined (e.g., averaged) to construct the global model's fully connected layer weights.

Embodiments provided herein enable users to build their own models while still employing a federated learning approach, which lets users make local decisions about which model type and architecture will work best for the user's local data, while benefiting from the input of other users through federated learning in a privacy-preserving manner. Embodiments can also reduce the overfitting and under-fitting problems previously discussed that can result when using a federated learning approach. Further, embodiments can handle different data distributions among the users, which current federated learning techniques cannot do.

According to a first aspect, a method on a central node or server is provided. The method includes receiving a first model from a first user device and a second model from a second user device, wherein the first model is of a neural network model type and has a first set of layers and the second model is of the neural network model type and has a second set of layers different from the first set of layers. The method further includes, for each layer of the first set of layers, selecting a first subset of filters from the layer of the first set of layers; and for each layer of the second set of layers, selecting a second subset of filters from the layer of the second set of layers. The method further includes constructing a global model by forming a global set of layers based on the first set of layers and the second set of layers, such that for each layer in the global set of layers, the layer comprises filters based on the corresponding first subset of filters and/or the corresponding second subset of filters; and forming a fully connected layer for the global model, wherein the fully connected layer is a final layer of the global set of layers.

In some embodiments, the method further includes sending to one or more user devices including the first user device and the second user device information regarding the fully connected layer for the global model; receiving one or more sets of coefficients from the one or more user devices, where the one or more sets of coefficients correspond to results from each of the one or more user devices training a device-specific local model using the information regarding the fully connected layer for the global model; and updating the global model by averaging the one or more sets of coefficients to create a new set of coefficients for the fully connected layer.

In some embodiments, selecting a first subset of filters from the layer of the first set of layers comprises determining the k best filters from the layer, wherein the first subset comprises the determined k best filters. In some embodiments, selecting a second subset of filters from the layer of the second set of layers comprises determining the k best filters from the layer, wherein the second subset comprises the determined k best filters. In some embodiments, forming a global set of layers based on the first set of layers and the second set of layers comprises: for each layer that is common to the first set of layers and the second set of layers, generating a corresponding layer in the global model by concatenating the corresponding first subset of filters and the corresponding second subset of filters; for each layer that is unique to the first set of layers, generating a corresponding layer in the global model by using the corresponding first subset of filters; and for each layer that is unique to the second set of layers, generating a corresponding layer in the global model by using the corresponding second subset of filters.

In some embodiments, the method further includes instructing one or more of a first user device and a second user device to distill its respective local model to the neural network model type.

According to a second aspect, a method on a user device for utilizing federated learning with heterogeneous model types and/or architectures is provided. The method includes distilling a local model to a first distilled model, wherein the local model is of a first model type and the first distilled model is of a second model type different from the first model type; transmitting the first distilled model to a server; receiving from the server a global model, wherein the global model is of the second model type; and updating the local model based on the global model.

In some embodiments, the method further includes updating the local model based on new data received at a user device; distilling the updated local model to a second distilled model, wherein the second distilled model is of the second model type; and transmitting a weighted average of the second distilled model and the first distilled model to the server. In some embodiments, the weighted average of the second distilled model and the first distilled model is given by W1+αW2, where W1 represents the first distilled model, W2 represents the second distilled model, and 0<α<1.

In some embodiments, the method further includes determining coefficients for a final layer of the global model based on local data; and sending to a central node or server the coefficients.

According to a third aspect, a central node or server is provided. The central node or server includes a memory; and a processor coupled to the memory. The processor is configured to: receive a first model from a first user device and a second model from a second user device, wherein the first model is of a neural network model type and has a first set of layers and the second model is of the neural network model type and has a second set of layers different from the first set of layers; for each layer of the first set of layers, select a first subset of filters from the layer of the first set of layers; for each layer of the second set of layers, select a second subset of filters from the layer of the second set of layers; construct a global model by forming a global set of layers based on the first set of layers and the second set of layers, such that for each layer in the global set of layers, the layer comprises filters based on the corresponding first subset of filters and/or the corresponding second subset of filters; and form a fully connected layer for the global model, wherein the fully connected layer is a final layer of the global set of layers.

According to a fourth aspect, a user device is provided. The user device includes a memory; and a processor coupled to the memory. The processor is configured to: distil a local model to a first distilled model, wherein the local model is of a first model type and the first distilled model is of a second model type different from the first model type; transmit the first distilled model to a server; receive from the server a global model, wherein the global model is of the second model type; and update the local model based on the global model.

According to a fifth aspect, a computer program is provided comprising instructions which when executed by processing circuitry causes the processing circuitry to perform the method of any one of the embodiments of the first or second aspects.

According to a sixth aspect, a carrier is provided containing the computer program of the fifth aspect, wherein the carrier is one of an electronic signal, an optical signal, a radio signal, and a computer readable storage medium.

### BRIEF DESCRIPTION OF THE DRAWINGS

The accompanying drawings, which are incorporated herein and form part of the specification, illustrate various embodiments.

FIG. 1 illustrates a federated learning system according to an embodiment.

FIG. 2 illustrates models according to an embodiment.

FIG. 3 illustrates a message diagram according to an embodiment.

FIG. 4 illustrates distillation according to an embodiment.

FIG. 5 illustrates a message diagram according to an embodiment.

FIG. 6 is a flow chart according to an embodiment.

FIG. 7 is a flow chart according to an embodiment.

FIG. 8 is a block diagram of an apparatus according to an embodiment.

FIG. 9 is a block diagram of an apparatus according to an embodiment.

### DETAILED DESCRIPTION

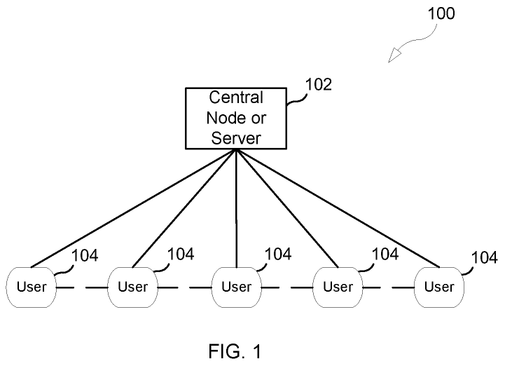

FIG. 1 illustrates a system 100 of federated learning according to an embodiment. As shown, a central node or server 102 is in communication with one or more users 104. Optionally, users 104 may be in communication with each other utilizing any of a variety of network topologies and/or network communication systems. For example, users 104 may include user devices such as a smart phone, tablet, laptop, personal computer, and so on, and may also be communicatively coupled through a common network such as the Internet (e.g., via WiFi) or a communications network (e.g., LTE or 5G). While a central node or server 102 is shown, the functionality of central node or server 102 may be distributed across multiple nodes and/or servers, and may be shared between one or more of users 104.

Federated learning as described in embodiments herein may involve one or more rounds, where a global model is iteratively trained in each round. Users 104 may register with the central node or server to indicate their willingness to participate in the federated learning of the global model, and may do so continuously or on a rolling basis. Upon registration (and potentially at any time thereafter), the central node or server 102 may select a model type and/or model architecture for the local user to train. Alternatively, or in addition, the central node or server 102 may allow each user 104 to select a model type and/or model architecture for itself. The central node or server 102 may transmit an initial model to the users 104. For example, the central node or server 102 may transmit to the users a global model (e.g., newly initialized or partially trained through previous rounds of federated learning). The users 104 may train their individual models locally with their own data. The results of such local training may then be reported back to central node or server 102, which may pool the results and update the global model. This process may be repeated iteratively. Further, at each round of training the global model, central node or server 102 may select a subset of all registered users 104 (e.g., a random subset) to participate in the training round.

Embodiments provide a new architectural framework where the users 104 can choose their own architectural models while training their system. In general, an architecture framework establishes a common practice for creating, interpreting, analyzing, and using architecture descriptions within a domain of application or stakeholder community. In typical federated learning systems, each user 104 has the same model type and architecture, so combining the model inputs from each user 104 to form a global model is relatively simple. Allowing users 104 to have heterogeneous model types and architectures, however, presents an issue with how to address such heterogeneity by the central node or server 102 that maintains the global model.

In some embodiments, each individual user 104 may have as a local model a particular type of neural network (such as a CNN). The specific model architecture for the neural network is unconstrained, and different users 104 may have different model architectures. For example, neural network architecture may refer to the arrangement of neurons into layers and the connection patterns between layers, activation functions, and learning methods. Referring specifically to CNNs, a model architecture may refer to the specific layers of the CNN, and the specific filters associated with each layer. In other words, in some embodiments different users 104 may each be training a local CNN type model, but the local CNN model may have different layers and/or filters between different users 104. Typical federated learning systems are not capable of handling this situation. Therefore, some modification of federated learning is needed. In particular, in some embodiments, the central node or server 102 generates a global model by intelligently combining the diverse local models. By employing this process, the central node or server 102 is able to employ federated learning over diverse model architectures. Allowing the model architecture to be unconstrained for a fixed model type may be referred to as the “same model type, different model architecture” approach.

In some embodiments, each individual user 104 may have as a local model any type of model and any architecture of that model type that the user 104 selects. That is, the model type is not constrained to a neural network, but can also include random forest type models, decision trees, and so on. The user 104 may train the local model in the manner suitable for the particular model. Prior to sharing the model updates with the central node or server 102 as part of a federated learning approach, the user 104 converts the local model to a common model type and in some embodiments a common architecture. This conversion process may take the form of model distillation, as disclosed herein for some embodiments. If the conversion is to a common model type and model architecture, then the central node or server 102 may essentially apply typical federated learning. If the conversion is to a common model type (such as a neural network type model), but not to a common model architecture, then the central node or server 102 may employ the “same model type, different model architecture” approach described for some embodiments. Allowing both the model type and model architecture to be unconstrained may be referred to as the “different model type, different model architecture” approach.

“Same model type, different model architecture”

As explained herein, different users 104 may have local models that have different model architecture between them but that share a common model type. In particular, it is assumed herein that the shared model type is a neural network model type. An example of this is the CNN model type. In this case, the objective is to combine the different models (e.g., the different CNN models) to intelligently form a global model. The different local CNN models may have different filter sizes and a different number of layers. More generally (e.g. when other types of neural network architectures are used), then instead of users having different layers or having layers with different filters (as discussed with CNNs), then different layers may include consideration of the neuron structure of the layers, e.g. different layers may have neurons having different weights.

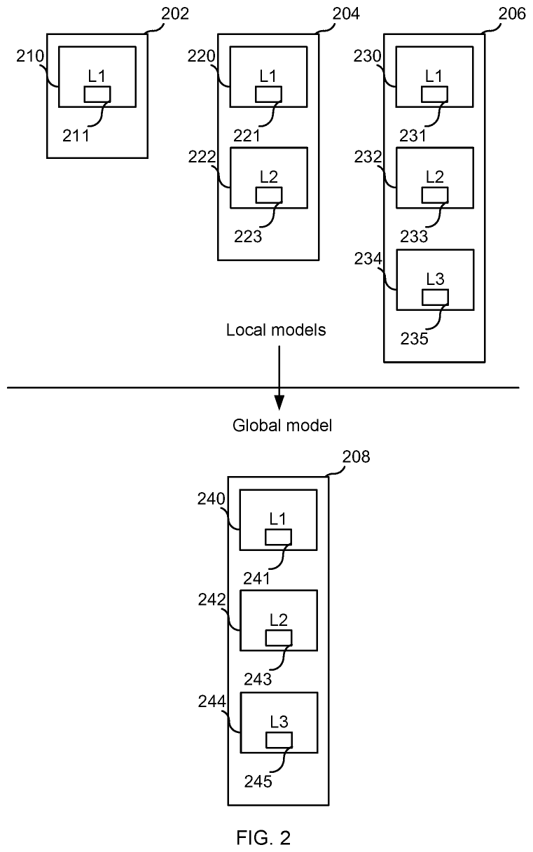

FIG. 2 illustrates models according to an embodiment. As shown, local models 202, 204, and 206 are each of the CNN model type, but have different architectures. For example, CNN model 202 includes a first layer 210 having a set of filters 211. CNN model 204 includes a first layer 220 having a set of filters 221 and a second layer 222 having a set of filters 223. CNN model 206 includes a first layer 230 having a set of filters 231, a second layer 232 having a set of filters 233, and a third layer 234 having a set of filters 235. The different local models 202, 204, and 206 may be combined to form a global model 208. Global CNN model 208 includes a first layer 240 having a set of filters 241, a second layer 242 having a set of filters 243, and a third layer 244 having a set of filters 245.

In some embodiments, some aspects of the model architecture may be shared between users 104 (e.g., a same first layer is used, or common filter types are used). It is also possible that two or more users 104 may employ the same architecture in whole. Generally, though, it is expected that different users 104 may select different model architectures to optimize local performance. Therefore, while each of models 202, 204, 206 have a first layer L1, the first layer L1 of each of models 202, 204, 206 may be differently composed e.g. by having different sets of filters 211, 221, 231.

Users 104 employing each of the local models 202, 204, and 206 may train their individual models locally, e.g. using local datasets (e.g., D1, D2, D3). Typically, the datasets will contain similar types of data, e.g. for training a classifier, each dataset might include the same classes, though the representatives for each class may differ between the datasets.

A global model is then constructed (or updated) based on the different local models. A central node or server 102 may be responsible for some or all of the functionality associated with constructing the global model. The individual user 104 (e.g. user devices) or other entities may also perform some steps and report results of those steps to the central node or server 102.

In general, the global model may be constructed by concatenating filters in each layer of each of the local models. In some embodiments, a subset of the filters of each layer may be used instead, such as by selecting the k-best filters of each layer. The value of k (e.g., k=2) may vary from one local model to another, and may vary from one layer within a local model to another layer. In some embodiments, the central node or server 102 may signal the value of k that each user 104 should use. In some embodiments, the two best filters (k=2) may be selected from each layer of each local model, while in other embodiments different values of k (e.g., k=1 or k>2) may be selected. In some embodiments, k may be selected to reduce the total number of filters in a layer by a relative amount (e.g., selecting the top one-third of the filters). Selection of the best filters may use any suitable technique to determine the best working filters. For example, the PCT application entitled “Understanding Deep Learning Models,” having application number PCT/IN2019/050455, describes some such techniques that may be used. Selecting a subset of filters in this way may help to reduce computational load, while also keeping accuracy high. In some embodiments, the central node or server 102 may perform the selection; in some embodiments, the user 104 or other entity may perform the selection and report the result to the central node or server 102.

Global model 208 will be used to explain this process. Each of local models 202, 204, and 206 includes a first layer L1. Therefore, global model 208 also includes a first layer L1, and the filters 241 of L1 of the global model 208 comprises the filters 211, 221, 231 (or a subset of the filters) of each of the local models 202, 204, and 206, concatenated together. Only local models 204 and 206 includes a second layer L2. Therefore, global model 208 also includes a second layer L2, and the filters 242 of L2 of the global model 208 comprises the filters 222, 232 (or a subset of the filters) of each of the local models 204 and 206, concatenated together. Only local model 206 includes a third layer L3. Therefore, global model 208 also includes a third layer L3, and the filters 245 of L3 of the global model 208 comprises the filters 235 (or a subset of the filters) of the local model 206.

In other words, if N(Mᵢ) represents the number of layers of local model Mᵢ, the global model will be constructed here to have at least max (N(Mᵢ)) layers, where the max operator is over all local models Mᵢ from which the global model is being constructed (or updated). For a given layer Lⱼ of the global model, the layer Lⱼ comprises the filters ⊕ᵢ Fᵢ, where the index i ranges over different local models having a j-th layer, and Fᵢ refers to the filters (or a subset of the filters) of the j-th layer of the particular local model Mᵢ. ⊕ represents concatenation, and ⊕_{i∈l} Fᵢ=Fᵢ where the set I={i}.

After concatenating the local models, the global model may further be constructed by adding a dense layer (e.g., a fully connected layer) to the model as the final layer.

Once the global model is thereby constructed (or updated), equations may be generated for training the model. These equations may be sent to the different users 104 who may each train the last dense layer, e.g. by keeping the other local filters the same. The users 104 that have trained the last dense layer locally may then report the model coefficients of their local dense layer to the central node or server 102. Finally, the global model may combine the model coefficients from the different users 104 that reported such coefficients to form the global model. For example, combining the model coefficients may include averaging the coefficients, including by using a weighted average such as weighted by amount of local data each user 104 trained on.

In embodiments, a global model constructed in this manner will be robust and contain the features learned from the different local models. Such a global model may work well, e.g. as a classifier. An advantage of this embodiment is also that the global model may be updated based only on a single user 104 (in addition to being updated based on input from multiple users 104). In this single-user update case, the weights of only last layer may be tuned by keeping everything else fixed.

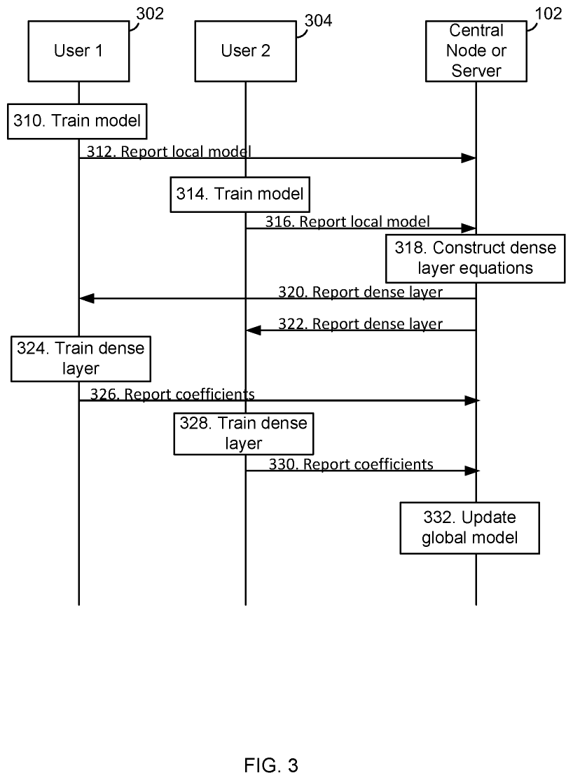

FIG. 3 illustrates a message diagram according to an embodiment. As shown, users 104 (e.g., a first user 302 and a second user 304) work with central node or server 102 to update a global model. First user 302 and second user 304 each train their respective local models at 310 and 314, and each report their local models to the central node or server 102 at 312 and 316. The training and reporting of the models may be simultaneous, or may be staggered to some degree. Central node or server 102 may wait until it receives model reports from each user 104 it is expecting a report on, or it may wait until a threshold number of such model reports are received, or it may wait a certain period of time, or any combination, before proceeding. Having received the model reports, central node or server 102 may construct or update the global model (e.g., as described above, such as by concatenating the filters or a subset of the filters of the different local models at each layer and adding a dense fully-connected layer as the final layer), and form equations needed for training the dense layer of the global model. Central node or server 102 then reports the dense layer equations to the first user 302 and second user 304 at 320 and 322. In turn, first user 302 and second user 304 train the dense layer using their local models at 324 and 328, and report back to the central node or server 102 with the coefficients to the dense layer equations that they have trained at 326 and 330. With this information, central node or server 102 may then update the global model by updating the dense layer based on the coefficients from local users 104.

“Different model type, different model architecture”

As explained herein, different users may have local models that have different model types and different model architectures. The problem to be addressed in this approach is that the unconstrained nature of both model type and model architecture among different local models makes merging different local models difficult to address, as there could be significant differences between the available model types, such that training applied to one model type may not have any significance to training applied to another model type. For example, users may fit different models such as random forest type models, decision trees, and so on.

To address this problem, embodiments convert the local model to a common model type and in some embodiments also to a common model architecture. One way of converting models is to use a model distillation approach. Model distillation may convert any model (e.g., a complex model trained on a lot of data) to a smaller, simpler model. The idea is to train the simpler model on the output of the complex model rather than the original output. This can translate the features learned on the complex model to the simpler model. In this way, any complex model can be translated to a simpler model by preserving features.

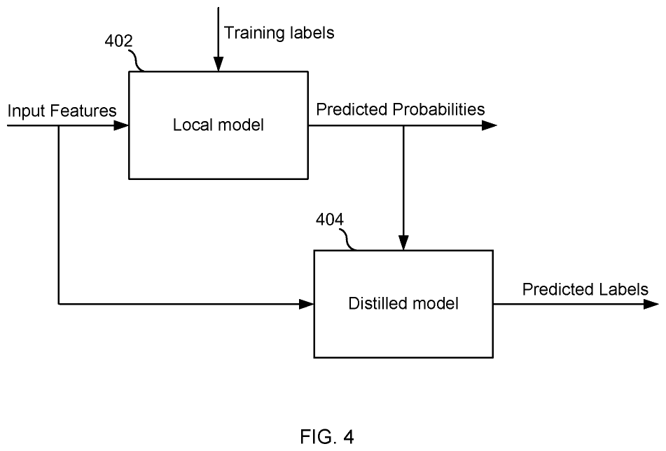

FIG. 4 illustrates distillation according to an embodiment. There are two models in distillation, the local model 402 (also referred to as the “teacher” model) and the distilled model 404 (also referred to as the “student” model). Usually, the teacher model is complex and trained using a GPU or another device with similar processing resources, whereas the student model is trained on a device having less powerful computational resources. This is not essential, but because the “student” model is easier to train than the original “teacher” model, it is possible to use less processing resources to train it. In order to keep the knowledge of the “teacher” model, the “student” model is trained on the predicted probabilities of the “teacher” model. The local model 402 and the distilled model 404 may be of different model types and/or model architectures.

In some embodiments, one or more individual users 104 having their own individual models of potentially different model type and model architecture may convert (e.g., by distilling) their local model into a distilled model of a specified model type and model architecture. For example, the central node or server 102 may instruct each user about what model type and model architecture the user 104 should distill a model into. The model type will be common to each user 104, but the model architecture may be different in some embodiments.

The distilled local models may then be sent to the central node or server 102, and there merged to construct (or update) the global model. The central node or server 102 then may send the global model to one or more of the users 104. In response, the users 104 who receive the updated global model may update their own individual local model based on the global model.

In some embodiments, the distilled model that is sent to the central node or server 102 may be based on a previous distilled model. Assume that a user 104 has previously sent (e.g., in the last round of federated learning) a first distilled model, representing a distillation of the user's 104 local model. The user 104 may then update a local model based on new data received at the user 104, and may distill a second distilled model based on the updated local model. The user 104 may then take a weighted average of the first and second distilled models (e.g., W1+αW2, where W1 represents the first distilled model, W2 represents the second distilled model, and 0<α<1) and send the weighted average of the first and second distilled models to the central node or server 102. The central node or server 102 may then use the weighted average to update the global model.

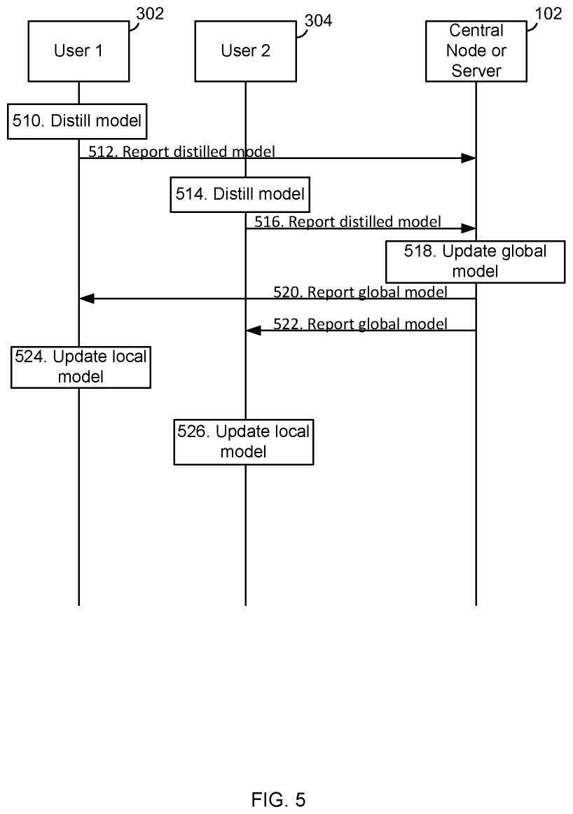

FIG. 5 illustrates a message diagram according to an embodiment. As shown, users 104 (e.g., a first user 302 and a second user 304) work with central node or server 102 to update a global model. First user 302 and second user 304 each distill their respective local models at 510 and 514, and each report their distilled models to the central node or server 102 at 512 and 516. The training and reporting of the models may be simultaneous, or may be staggered to some degree. Central node or server 102 may wait until it receives model reports from each user 104 it is expecting a report on, or it may wait until a threshold number of such model reports are received, or it may wait a certain period of time, or any combination, before proceeding. Having received the model reports, central node or server 102 may construct or update the global model 318 (e.g., as described in disclosed embodiments). Central node or server 102 then reports the global model to the first user 302 and second user 304 at 520 and 522. In turn, first user 302 and second user 304 then update their respective local model based on the global model (e.g., as described in disclosed embodiments) at 524 and 526.

Returning to the example of each user 102 having different model architectures for the same CNN model type, a mathematical formulation relevant to proposed embodiments is provided. For a given CNN, the output of each filter may be represented as

$$\hat{y} [ i ] = f ( {\sum }_{j = 1}^{P} {\sum }_{k = 1}^{M} in [ k ] c [ j ] ) , i = 1 , … , N$$

which is valid for N filters, and where input data (in[k]) is of size M and filter (c) is of size P with a stride of 1. That is, in[k] represents the k-th element of the input (of size M) of the filter, and c[j] is the j-th element of the filter (of size P). Also, for explanatory purposes, only one layer is considered in this CNN model. The above representation ensures the dot product between the input data and filter coefficients. From this representation, the filter coefficients c can be learned by using backpropagation. Typically, out of these filters, only a small number (e.g., two or three) of the filters will work well. Hence, the equation above can be reduced to only a subset N_{S} (N_{S}≤N) of filters that are working well. These filters (i.e. that work well compared to the others) may be obtained in a variety of methods, as discussed above.

As discussed herein, a global model can then be constructed which takes the filters of each of the different users' models for each layer and concatenates them. The global model also includes as a final layer a fully-connected dense layer. For a fully connected layer having L nodes (or neurons), the mathematical formulation of the layer may be represented as:

$$\hat{y} [ ι ] = g ( W * flatten ( f ( {\sum }_{j = 1}^{M} {\sum }_{k = 1}^{P} in [ k ] {c}_{m} [ j ] ) ) + b ) , i = 1 , … , {N}_{s}$$

where cₘ represents one of the filters from the subset of the best working filters, W is the set of weights of the final layer, b is bias, and g(.) is the activation function of the final layer. The input to the fully connected layer will be flattened before passing on to the layer. This equation is sent to each of the users to compute the weights using the regular backpropagation technique. Assuming that the weights learned by the different users are W₁, W₂, . . . , W_{U}, where U is the number of users in the federated learning approach, the global model final layer weights may be determined by an averaging such as

$${W}_{G} = \frac{1}{U} ( {W}_{1} + {W}_{2} + … + {W}_{U} )$$

### EXAMPLE

The following example was prepared to evaluate the performance of an embodiment. Alarm datasets corresponding to three telecom operators were collected. The three telecom operators correspond to three different users. The alarm datasets have the same features and have different patterns. The objective is to classify the alarm as a true alarm and a false alarm based on the features.

The users may select their own model. In this example, each user may select a specific architecture for a CNN model type. That is, each user may select a different number of layers and different filters in each of the layers as compared to the other users.

For this example, operator 1 (first user) selects to fit a three-layer CNN with 32 filters in a first layer, 64 filters in a second layer and 32 filters in the last layer. Similarly, operator 2 (second user) selects to fit a two-layer CNN with 32 layers in a first layer and 16 layers in a second layer. Lastly, operator 3 (third user) selects to fit a five-layer CNN with 32 filters in each of the first four layers and 8 filters in a fifth layer. These models are chosen based on the nature of data available to each operator, and the models may be selected based on the current round of federated learning.

The global model is constructed as follows. The number of layers in the global model contains maximum number of layers as the different local models have, which here is 5 layers. The top two filters in each layer of each local model was identified, and the global model is constructed with two filters from each layer of each local model. Specifically, the first layer of global model contains 6 filters (from first layer of each local model), the second layer contains 6 filters (from second layer of each local model), the third layer contains two filters from first model and two filters from third model, the fourth layer contains two filters from fourth layer of third model, and fifth layer contains two filters from fifth layer of third model. Next, the dense fully connected layer is constructed as the final layer of the global model. The dense layer has 10 nodes (neurons). Once constructed, the global model is sent to the user for training the last layer, and the results (coefficients) of each local model's training are collected. These coefficients are then averaged to obtain the last layer of the global model.

Applying this to the three datasets for the telecom operators, the accuracies obtained for the local models are 82%, 88%, and 75%. Once the global model is constructed, the accuracies obtained at local models are improved to 86%, 94%, and 80%. As can be seen in the example, the federated learning model of disclosed embodiments is good and can result in a better model when compared with local models.

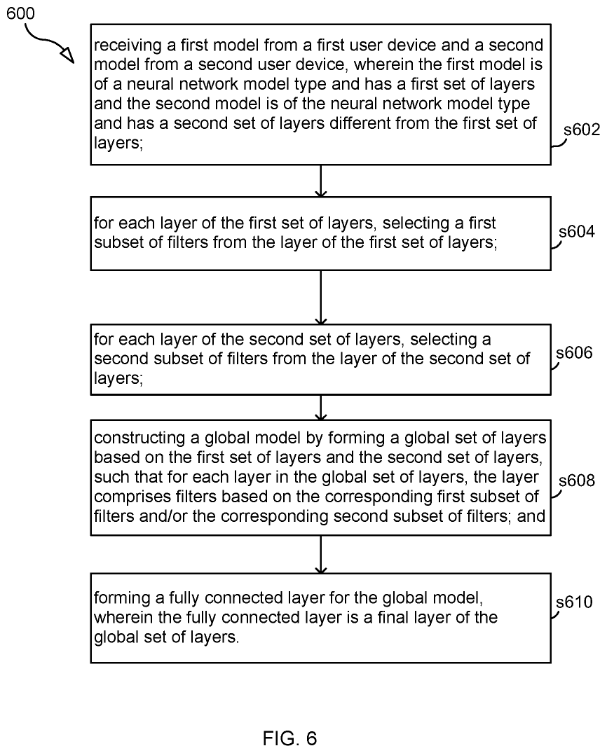

FIG. 6 illustrates a flow chart according to an embodiment. Process 600 is a method performed by a central node or server. Process 600 may begin with step s602.

Step s602 comprises receiving a first model from a first user device and a second model from a second user device, wherein the first model is of a neural network model type and has a first set of layers and the second model is of the neural network model type and has a second set of layers different from the first set of layers.

Step s604 comprises, for each layer of the first set of layers, selecting a first subset of filters from the layer of the first set of layers.

Step s606 comprises, for each layer of the second set of layers, selecting a second subset of filters from the layer of the second set of layers.

Step s608 comprises constructing a global model by forming a global set of layers based on the first set of layers and the second set of layers, such that for each layer in the global set of layers, the layer comprises filters based on the corresponding first subset of filters and/or the corresponding second subset of filters.

Step s610 comprises forming a fully connected layer for the global model, wherein the fully connected layer is a final layer of the global set of layers.

In some embodiments, the method may further include sending to one or more user devices including the first user device and the second user device information regarding the fully connected layer for the global model; receiving one or more sets of coefficients from the one or more user devices, where the one or more sets of coefficients correspond to results from each of the one or more user devices training a device-specific local model using the information regarding the fully connected layer for the global model; and updating the global model by averaging the one or more sets of coefficients to create a new set of coefficients for the fully connected layer.

In some embodiments, selecting a first subset of filters from the layer of the first set of layers comprises determining the k best filters from the layer, wherein the first subset comprises the determined k best filters. In some embodiments, selecting a second subset of filters from the layer of the second set of layers comprises determining the k best filters from the layer, wherein the second subset comprises the determined k best filters. In some embodiments, forming a global set of layers based on the first set of layers and the second set of layers comprises: for each layer that is common to the first set of layers and the second set of layers, generating a corresponding layer in the global model by concatenating the corresponding first subset of filters and the corresponding second subset of filters; for each layer that is unique to the first set of layers, generating a corresponding layer in the global model by using the corresponding first subset of filters; and for each layer that is unique to the second set of layers, generating a corresponding layer in the global model by using the corresponding second subset of filters.

In some embodiments, the method may further include instructing one or more of a first user device and a second user device to distill its respective local model to the neural network model type.

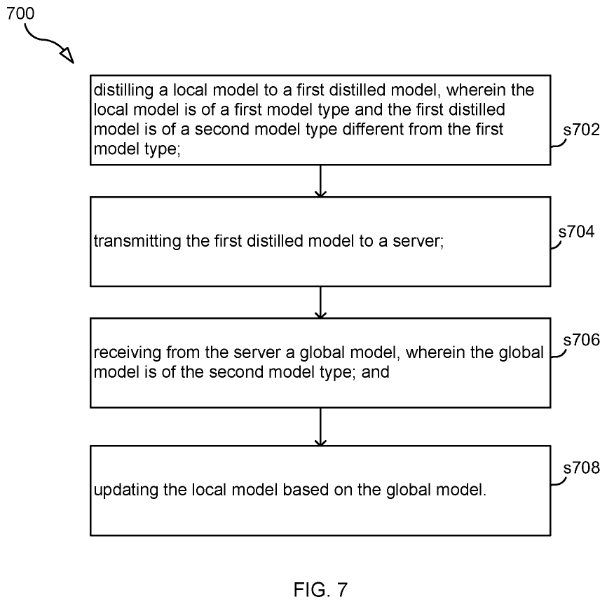

FIG. 7 illustrates a flow chart according to an embodiment. Process 700 is a method performed by a user 104 (e.g. a user device). Process 700 may begin with step s702.

Step s702 comprises distilling a local model to a first distilled model, wherein the local model is of a first model type and the first distilled model is of a second model type different from the first model type.

Step s704 comprises transmitting the first distilled model to a server.

Step s706 comprises receiving from the server a global model, wherein the global model is of the second model type.

Step s708 comprises updating the local model based on the global model.

In some embodiments, the method may further include updating the local model based on new data received at a user device; distilling the updated local model to a second distilled model, wherein the second distilled model is of the second model type; and transmitting a weighted average of the second distilled model and the first distilled model to the server. In some embodiments, the weighted average of the second distilled model and the first distilled model is given by W1+αW2, where W1 represents the first distilled model, W2 represents the second distilled model, and 0<α<1.

In some embodiments, the method may further include determining coefficients for a final layer of the global model based on local data; and sending to a central node or server the coefficients.

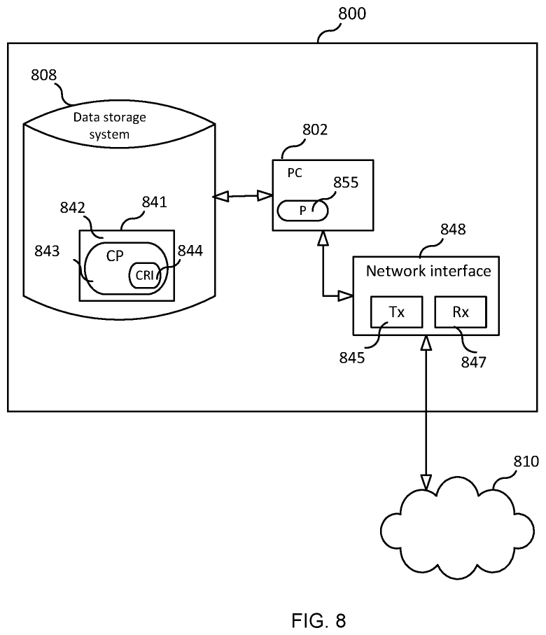

FIG. 8 is a block diagram of an apparatus 800 (e.g., a user 102 and/or central node or server 104), according to some embodiments. As shown in FIG. 8, the apparatus may comprise: processing circuitry (PC) 802, which may include one or more processors (P) 855 (e.g., a general purpose microprocessor and/or one or more other processors, such as an application specific integrated circuit (ASIC), field-programmable gate arrays (FPGAs), and the like); a network interface 848 comprising a transmitter (Tx) 845 and a receiver (Rx) 847 for enabling the apparatus to transmit data to and receive data from other nodes connected to a network 810 (e.g., an Internet Protocol (IP) network) to which network interface 848 is connected; and a local storage unit (a.k.a., “data storage system”) 808, which may include one or more non-volatile storage devices and/or one or more volatile storage devices. In embodiments where PC 802 includes a programmable processor, a computer program product (CPP) 841 may be provided. CPP 841 includes a computer readable medium (CRM) 842 storing a computer program (CP) 843 comprising computer readable instructions (CRI) 844. CRM 842 may be a non-transitory computer readable medium, such as, magnetic media (e.g., a hard disk), optical media, memory devices (e.g., random access memory, flash memory), and the like. In some embodiments, the CRI 844 of computer program 843 is configured such that when executed by PC 802, the CRI causes the apparatus to perform steps described herein (e.g., steps described herein with reference to the flow charts). In other embodiments, the apparatus may be configured to perform steps described herein without the need for code. That is, for example, PC 802 may consist merely of one or more ASICs. Hence, the features of the embodiments described herein may be implemented in hardware and/or software.

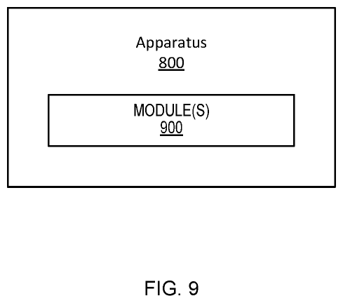

FIG. 9 is a schematic block diagram of the apparatus 800 according to some other embodiments. The apparatus 800 includes one or more modules 900, each of which is implemented in software. The module(s) 900 provide the functionality of apparatus 800 described herein (e.g., the steps herein, e.g., with respect to FIGS. 6-7).

While various embodiments of the present disclosure are described herein, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may he omitted, the order of the steps may he re-arranged, and some steps may be performed in parallel.

1. A method comprising:
receiving a first model from a first user device and a second model from a second user device, wherein the first model is of a neural network model type and has a first set of layers and the second model is of the neural network model type and has a second set of layers different than the first set of layers;
for each layer of the first set of layers, selecting a first subset of filters from the layer of the first set of layers;
for each layer of the second set of layers, selecting a second subset of filters from the layer of the second set of layers;
constructing a global model by forming a global set of layers based on the first set of layers and the second set of layers, such that for each layer in the global set of layers, the layer comprises filters based on the corresponding first subset of filters and/or the corresponding second subset of filters; and
forming a fully connected layer for the global model, wherein the fully connected layer is a final layer of the global set of layers.

2. The method of claim 1, further comprising:
sending to one or more user devices including the first user device and the second user device information regarding the fully connected layer for the global model;
receiving one or more sets of coefficients from the one or more user devices, where the one or more sets of coefficients correspond to results from each of the one or more user devices training a device-specific local model using the information regarding the fully connected layer for the global model; and
updating the global model by averaging the one or more sets of coefficients to create a new set of coefficients for the fully connected layer.

3. The method of claim 1, wherein selecting a first subset of filters from the layer of the first set of layers comprises determining the k best filters from the layer, wherein the first subset comprises the determined k best filters.

4. The method of claim 1, wherein selecting a second subset of filters from the layer of the second set of layers comprises determining the k best filters from the layer, wherein the second subset comprises the determined k best filters.

5. The method of claim 1, wherein forming a global set of layers based on the first set of layers and the second set of layers comprises:
for each layer that is common to the first set of layers and the second set of layers, generating a corresponding layer in the global model by concatenating the corresponding first subset of filters and the corresponding second subset of filters;
for each layer that is unique to the first set of layers, generating a corresponding layer in the global model by using the corresponding first subset of filters; and
for each layer that is unique to the second set of layers, generating a corresponding layer in the global model by using the corresponding second subset of filters.

6. The method of claim 1, further comprising instructing one or more of a first user device and a second user device to distill its respective local model to the neural network model type.

7. A method on a user device for utilizing federated learning with heterogeneous model types and/or architectures, the method comprising:
distilling a local model to a first distilled model, wherein the local model is of a first model type and the first distilled model is of a second model type different than the first model type;
transmitting the first distilled model to a server;
receiving from the server a global model, wherein the global model is of the second model type; and
updating the local model based on the global model.

8. The method of claim 7, further comprising:
updating the local model based on new data received at a user device;
distilling the updated local model to a second distilled model, wherein the second distilled model is of the second model type;
transmitting a weighted average of the second distilled model and the first distilled model to the server.

9. The method of claim 8, wherein the weighted average of the second distilled model and the first distilled model is given by W1+αW2, where W1 represents the first distilled model, W2 represents the second distilled model, and 0<α<1.

10. The method of claim 7, further comprising:
determining coefficients for a final layer of the global model based on local data; and
sending to a central node or server the coefficients.

11. An apparatus comprising:
a memory; and
a processor coupled to the memory, wherein the apparatus is configured to:
receive a first model from a first user device and a second model from a second user device, wherein the first model is of a neural network model type and has a first set of layers and the second model is of the neural network model type and has a second set of layers different than the first set of layers;
for each layer of the first set of layers, select a first subset of filters from the layer of the first set of layers;
for each layer of the second set of layers, select a second subset of filters from the layer of the second set of layers;
construct a global model by forming a global set of layers based on the first set of layers and the second set of layers, such that for each layer in the global set of layers, the layer comprises filters based on the corresponding first subset of filters and/or the corresponding second subset of filters; and
form a fully connected layer for the global model, wherein the fully connected layer is a final layer of the global set of layers.

12. The apparatus of claim 11, wherein the apparatus is further configured to:
send to one or more user devices including the first user device and the second user device information regarding the fully connected layer for the global model;
receive one or more sets of coefficients from the one or more user devices, where the one or more sets of coefficients correspond to results from each of the one or more user devices training a device-specific local model using the information regarding the fully connected layer for the global model; and
update the global model by averaging the one or more sets of coefficients to create a new set of coefficients for the fully connected layer.

13. The apparatus of claim 11, wherein selecting a first subset of filters from the layer of the first set of layers comprises determining the k best filters from the layer, wherein the first subset comprises the determined k best filters.

14. The apparatus of claim 11, wherein selecting a second subset of filters from the layer of the second set of layers comprises determining the k best filters from the layer, wherein the second subset comprises the determined k best filters.

15. The apparatus of claim 11, wherein forming a global set of layers based on the first set of layers and the second set of layers comprises:
for each layer that is common to the first set of layers and the second set of layers, generating a corresponding layer in the global model by concatenating the corresponding first subset of filters and the corresponding second subset of filters;
for each layer that is unique to the first set of layers, generating a corresponding layer in the global model by using the corresponding first subset of filters; and
for each layer that is unique to the second set of layers, generating a corresponding layer in the global model by using the corresponding second subset of filters.

16. The apparatus of claim 11, wherein the apparatus is further configured to instruct one or more of a first user device and a second user device to distill its respective local model to the neural network model type.

17. A user device comprising:
a memory;
a processor coupled to the memory, wherein the user device is configured to:
distil a local model to a first distilled model, wherein the local model is of a first model type and the first distilled model is of a second model type different from the first model type;
transmit the first distilled model to a server;
receive from the server a global model, wherein the global model is of the second model type; and
update the local model based on the global model.

18. The user device of claim 17, wherein the user device is further configured to:
update the local model based on new data received at a user device;
distil the updated local model to a second distilled model, wherein the second distilled model is of the second model type;
transmit a weighted average of the second distilled model and the first distilled model to the server.

19. The user device of claim 18, wherein the weighted average of the second distilled model and the first distilled model is given by W1+αW2, where W1 represents the first distilled model, W2 represents the second distilled model, and 0<α<1.

20. The user device of claim 17, wherein the user device is further configured to:
determine coefficients for a final layer of the global model based on local data; and
send to a central node or a server the coefficients.

21. A non-transitory computer readable medium storing a computer program comprising instructions which when executed by processing circuitry of an apparatus causes the apparatus to perform the method of claim 1.

22. (canceled)
